(19) United States
(12) Patent Application Publication
(10) Pub. No.: US 2017/0061458 A1
(43) Pub. Date: Mar. 2, 2017

(54) METHOD OF COMPILING CITY GUIDE DATABASE USING PAYMENT SYSTEM DATA

(71) Applicant: MasterCard International Incorporated, Purchase, NY (US)

(72) Inventors: Arun Elangovan, Astoria, NY (US); Anshul Pandey, Gurgaon (IN)

(21) Appl. No.: 14/842,213

(22) Filed: Sep. 1, 2015

(51) Int. Cl. G06Q 30/02; G06F 3/0481; G06Q 50/22; G06Q 30/06; G06Q 50/12

(52) U.S. Cl. CPC G06Q 30/0205; G06Q 30/0629; G06Q 30/0639; G06Q 30/0641; G06Q 50/12; G06Q 50/22; G06F 3/0481

(57) ABSTRACT

A method includes receiving transaction data from a payment network. The transaction data may represent payment account transactions. A subset of the transaction data may be associated with a district in an urban area. A summary characteristic of the district may be generated on the basis of the subset of transaction data associated with the district. The district may be represented by a color or a shade on a map. The map may be transmitted to a user's mobile device.

### BACKGROUND

Numerous mobile device applications (apps) have been proposed to aid users in locating particular retail stores or types of stores. Numerous location-based mobile apps have also been proposed. Many apps in these categories rely on self-reporting by retailers and/or input from users, and may be lacking in accuracy and/or comprehensiveness.

The present inventors have now recognized that there are opportunities to improve location-based apps, and to provide better guidance to travelers than is available from existing apps.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system that may be a source of information utilized according to some aspects of this disclosure.

FIG. 2 is a functional block diagram representation of a system for providing location-based information according to aspects of this disclosure.

FIG. 3 is a block diagram representation of a computer system provided according to aspects of the present disclosure.

FIGS. 4 and 5 are flow charts that illustrate aspects of the present disclosure, including a portion of the operations of the computer system of FIG. 3.

FIG. 6 is a simplified illustration of a location-based information display that may be provided in accordance with aspects of the present disclosure.

FIG. 7 is a block diagram that illustrates other aspects of the system of FIG. 2.

FIG. 8 is a simplified block diagram representation of a mobile device shown in FIG. 7.

### DETAILED DESCRIPTION

In general, and for the purpose of introducing concepts of embodiments of the present disclosure, transaction data generated in a payment system may be analyzed to provide information on a district-by-district basis in support of a mobile city-guide app or website or the like. The transaction data may be used to characterize city districts in a number of ways, including price levels and customary business hours. Information may be provided to users in visual form, including maps showing city districts, with color-coding or other visual distinctions among districts to reflect variations in characteristics among districts.

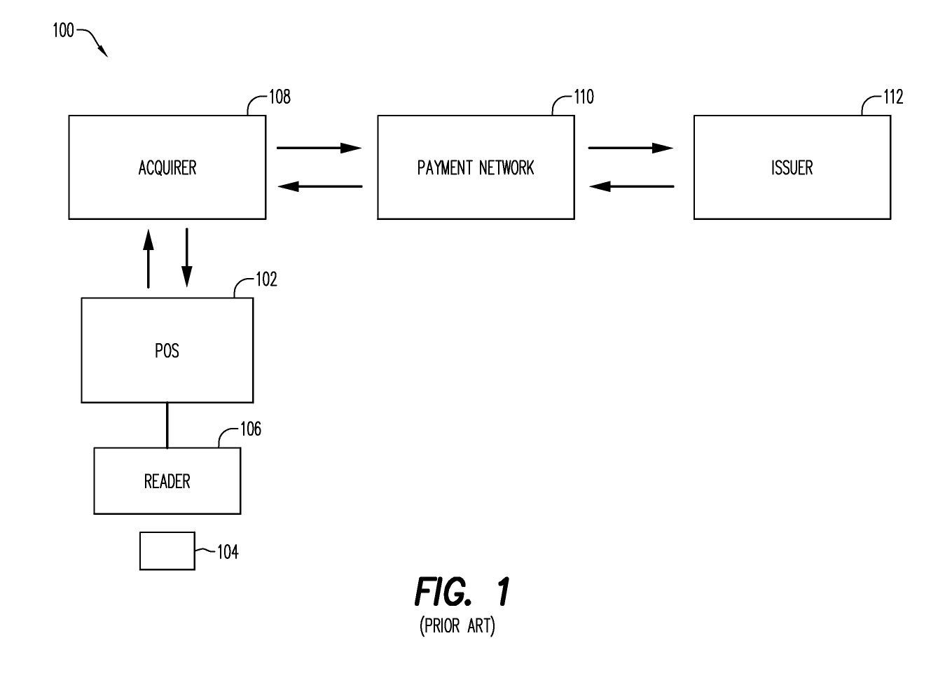

FIG. 1 is a block diagram that illustrates a conventional payment system 100 that may be a source of transaction data utilized according to some aspects of this disclosure. In particular, the representation of the payment system 100 in FIG. 1 reflects the flow of information and messaging for a single payment account transaction.

Thus, the transaction in question may originate at a POS (point of sale) device 102 located in a merchant store (which is not separately indicated). A payment card 104 is shown being presented to a reader component 106 associated with the POS device 102. The payment card 104 is often implemented as a physical magnetic stripe card, although alternatively, or in addition, the payment card 104 may include capability for being read by proximity RF (radio frequency) communication with an integrated circuit (IC) chip (not separately shown), or via a contact interface with the reader component 106. Alternatively, the payment card 104 may encompass a virtual card account number or an electronic wallet, as is known in the art. The primary account number (PAN) for the payment card account represented by the payment card 104 may be stored on the magnetic stripe (not separately shown) and/or the IC chip (if present) for reading by the reader component 106 of the POS device 102.

In some installations, the reader component 106 may be configured to perform either or both of magnetic stripe reading and reading of IC chips by proximity RF communications. Thus, the payment card 104 may be swiped through a mag stripe reading portion (not separately shown) of the reader component 106, or may be tapped on a suitable surface of the reader component 106 to allow for proximity reading of its IC chip, or presented to a contact interface of the reader component 106.

In some transactions, instead of a card-shaped payment device, such as the payment card 104, a suitable conventional payment-enabled mobile phone or a payment fob may be presented to and read by the reader component 106.

A computer 108 operated by an acquirer (acquiring financial institution) is also shown as part of the payment system 100 in FIG. 1. The acquirer computer 108 may operate to receive an authorization request for the transaction from the POS device 102. The acquirer computer 108 may route the authorization request via a payment network 110 to the server computer 112 operated by the issuer of the payment account that is available for access by the payment card 104. The authorization response generated by the payment account issuer server computer 112 may be routed back to the POS device 102 via the payment network 110 and the acquirer computer 108.

The authorization request and/or the authorization response are data messages that pass through the payment network 110. The information contained in the messages may include transaction date, day and time, transaction amount, the merchant's name, a category or classification code for the merchant and the merchant location. The payment network may operate to capture and store the quantities of transaction data that represent purchase transactions handled by the payment network

The payment network 110 may be, for example, the well-known Banknet system operated by MasterCard International Incorporated, which is the assignee hereof.

The components of the system 100 as depicted in FIG. 1 are only those that are needed for processing a single transaction. A typical payment system 100 now in use may include a considerable number of payment card issuers and their computers, a considerable number of acquirers and their computers, and numerous merchants and their POS devices and associated reader components. The system may also include a very large number of payment account holders, who carry payment cards and/or other payment-enabled devices.

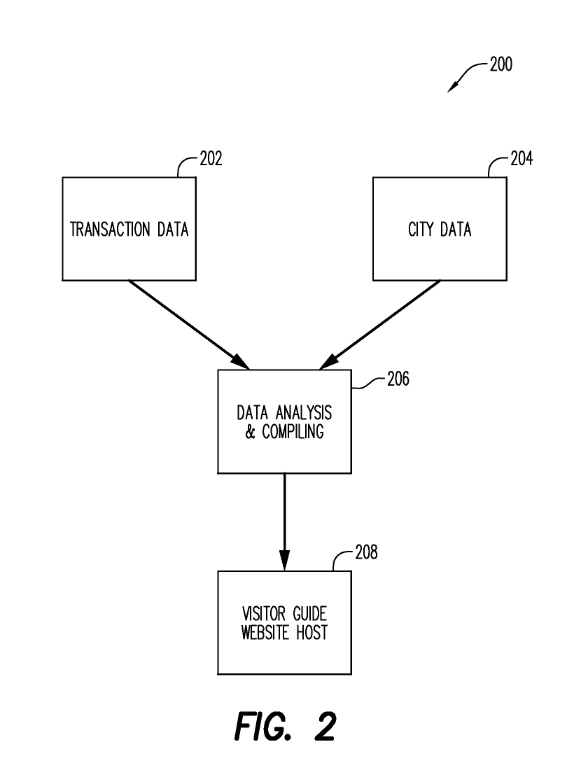

FIG. 2 is a functional block diagram representation of a system 200 for providing location-based information according to aspects of this disclosure. Shown as part of the system 200 is a resource/repository 202 of the transaction data described above in connection with FIG. 1. In some embodiments, the transaction data resource 202 may be associated with the payment network 110 (FIG. 1) and may be maintained in the ordinary course of operation of the payment network 110. In other embodiments, the transaction data resource 202 may be derived from a conventional transaction database (not separately shown) so as to be particularly adapted for use in the system 200.

Another functional element of the system 200 is a city data resource 204. The city data resource 204 may be assembled and/or derived from commercially available data resources (not separately shown) and/or may be constructed by individuals with special knowledge relating to various cities, and may reflect and/or include data generated by such expert individuals specifically for inclusion in the city data resource 204. The city data resource 204 may, for example, include detailed data about one or more cities, including maps of the city, postal code area boundaries, neighborhood district boundaries, locations and other data concerning shopping centers and malls, and/or maps showing various areas of the city(ies) as they are commonly referred to by residents and/or city guides; such maps may or may not reflect political subdivisions of the city. As used in the descriptions herein, the term “city” may refer either to a city proper or to a metropolitan area including adjacent and/or more distant suburban districts. The data resources for each city may be specially designed by local experts so as to be useful for travelers.

Block 206 in FIG. 2 represents the function of drawing data from the transaction data resource 202 and the city data resource 204 to analyze, compile and/or generate data that may characterize city districts and/or guide visitors and other users in accordance with aspects of the present disclosure. As will be seen, the functional block 206 may be partially or entirely constituted by a city guide computer which will be described below.

Also shown in FIG. 2 is a website host 208, which may function as an internet destination for users of computing devices/browsers (not shown). The website host 208 may be integrated with block 206 and/or may store and make available to users data compiled and/or generated by the block 206.

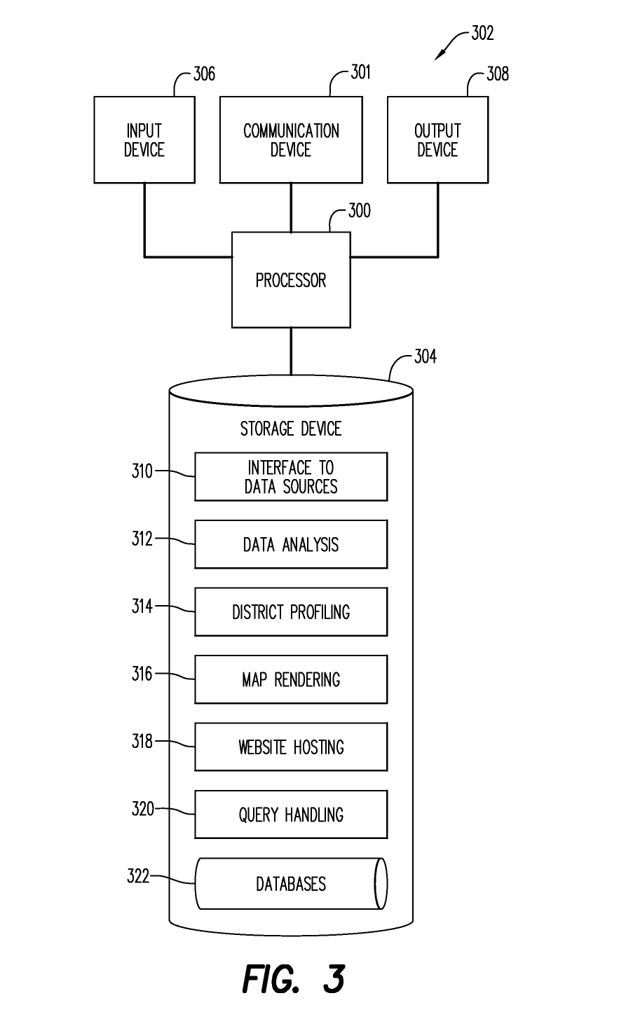

At least some of the functionality represented by blocks 206 and 208 in FIG. 2 may be implemented in a computer system operated, e.g., by an operator of a payment network such as the payment network 110 shown in FIG. 1. As noted above, one operator of such a payment network is MasterCard International Incorporated, the assignee of this disclosure. A computer system that implements some or all of blocks 206 and 208 may hereinafter be referred to as a “city guide computer.” FIG. 3 is a block diagram illustration of such a computer, which is generally indicated in the drawing by reference numeral 302. In the description below, it is assumed that the functions of blocks 206 and 208 are performed in an integrated installation of computer hardware. In other embodiments, however, the functionality of blocks 206 and 208 may be divided among two or more different computers, with data communications and/or batch downloads of information occurring among the different computers.

Referring then to FIG. 3, the city guide computer 302 may be constituted by server computer hardware and/or mainframe computer hardware.

The city guide computer 302 may include a computer processor 300 operatively coupled to a communication device 301, a storage device 304, an input device 306 and an output device 308.

The computer processor 300 may be constituted by one or more processors, including multi-core processing devices. Processor 300 operates to execute processor-executable steps, contained in program instructions described below, so as to control the city guide computer 302 to provide desired functionality.

Communication device 301 may be used to facilitate communication with, for example, other devices (such as one or more devices operated by individual users, as discussed below). For example, communication device 301 may comprise numerous communication ports (not separately shown), to allow the city guide computer 302 to communicate simultaneously with a number of other computers and other devices.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the city guide computer 302, executed by the processor 300 to cause the city guide computer 302 to function as described herein.

The programs may include one or more conventional operating systems (not shown) that control the processor 300 so as to manage and coordinate activities and sharing of resources in the city guide computer 302, and to serve as a host for application programs (described below) that run on the city guide computer 302.

The programs stored in the storage device 304 may also include a software interface 310 that controls the processor 300 to enable the city guide computer 302 to obtain downloads of data from the data sources 202 and 204 shown in FIG. 2. In some embodiments, the data source interface 310 may operate such that the city guide computer 302 is able to access data from the data sources 202 and 204 as needed for data analysis and/or compilation operations under way from time to time in the city guide computer 302.

Continuing to refer to FIG. 3, another program that may be stored in the storage device 304 is an application program 312 that controls the processor 300 to enable the city guide computer 302 to analyze data obtained by the city guide computer 302 from the data sources 202, 204. For example, as described in more detail below, the data analysis program 312 may be guided by data from the city data source 204 to obtain and analyze transaction data from the transaction data source 202 to detect certain collective characteristics of merchants located in a given district in a given city.

Still further, and continuing to refer to FIG. 3, the storage device 304 may also store a district profile generation application program 314. The district profile generation application program 314 may control the processor 300 to enable the city guide computer 302 to generate profiles of one or more districts in one or more cities based on analysis performed by the data analysis program 312. Examples of contents of district profiles generated by the district profile generation application program 314 will be described below.

In addition, and continuing to refer to FIG. 3, the storage device 304 may also include a map rendering software module 316. The map rendering software module 316 may control the processor 300 such that the city guide computer 302 is enabled to provide maps for downloading to user devices. The maps may show portions of cities with districts within the cities illustrated in accordance with characteristics of the districts determined, e.g., by the data analysis program 312 and/or the district profile generation application program 314.

Moreover, the storage device 304 may further store a website hosting application program 318 that enables the city guide computer 302 to perform basic website hosting functions as a platform for hosting a city guide website provided for users in accordance with aspects of the present disclosure.

Still further, the storage device 304 may store a query handling application program 320 that enables the city guide computer 302 to handle requests for information from, e.g., users who have employed browser-equipped devices (not shown) to navigate to the website hosted by the city guide computer 302. As will be seen from subsequent discussion, the queries to the city guide computer 302 may seek information about one or more districts in a city that is being visited by the user in question.

The storage device 304 may also store, and the city guide computer 302 may also execute, other programs, which are not shown. For example, such programs may include communications software and a reporting application. The latter program may respond to requests from system administrators for reports on the activities performed by the city guide computer 302. The other programs may also include, e.g., device drivers, etc.

The storage device 304 may also store one or more databases 322 needed for operation of the city guide computer 302.

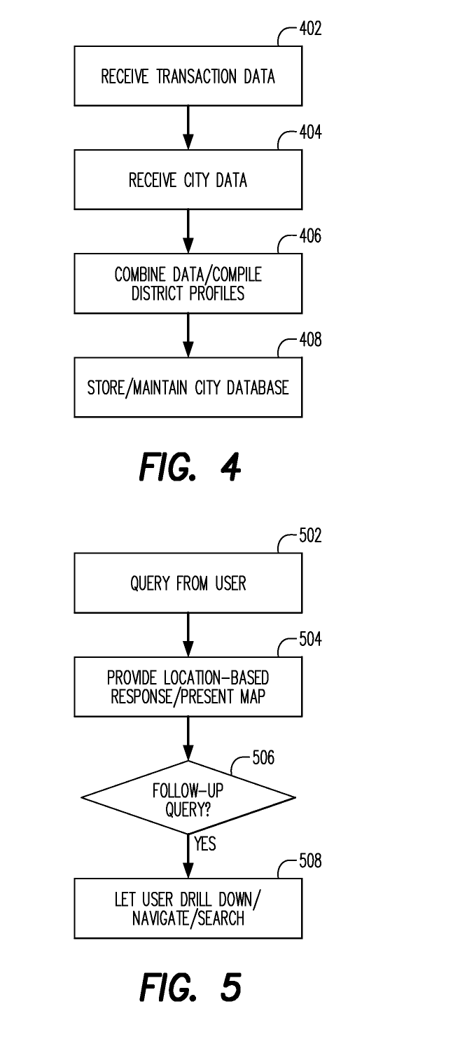

FIG. 4 is a flow chart that illustrates aspects of the present disclosure, including a portion of the operations of the city guide computer 302 (FIG. 3).

At 402 in FIG. 4, the city guide computer 302 may receive transaction data from the data source 202 (FIG. 2), referred to above. In some embodiments, the transaction data may be limited to data that reflects transactions that occurred in a specific city. In addition or alternatively, the transaction data may be limited to data that reflects transactions that occurred in one or more categories of merchants. In some embodiments, to assure timeliness, the transaction data may reflect only transactions that occurred in the past year.

At 404 in FIG. 4, the city guide computer 302 may receive data from the city data source 204 (FIG. 2). For example, the city data (i.e., data from source 204) may define a number of districts of a particular city for which the city guide computer 302 has obtained transaction data. For example, the city data may enumerate the streets and street number ranges that are contained within each district of the city.

At 406, the city guide computer 302 may analyze, combine and/or compile the data received at 402 and 404. The processing that occurs at 406 may result in generation of district profiles for one or more districts in a particular city. The profiles may be based on transaction data that has been sorted together based on the city data. For example, in some embodiments, the city guide computer 302 may assign one or more subsets of the transaction data to a particular city district based on the merchant location data (e.g., street address) that may be contained in the transaction data.

For example, the city guide computer 302 may assemble all transactions that occurred in restaurants in a particular district. The city guide computer 302 may analyze the transactions to arrive at a characteristic of the district.

For example, the city guide computer 302 may average the total transaction amounts indicated for the restaurant transactions to arrive at an average price level for restaurants in the district. In some embodiments, the city guide computer 302 may sub-group the restaurant transactions by time of day, so that the average transaction amount is not distorted by taking the average over different categories of meals, such as breakfasts versus lunches versus dinners. In some embodiments, the city guide computer may disregard any transactions that did not occur at dinner time, so as to arrive at a price level that reflects dinnertime pricing of the restaurants in the district.

As another type of example of the analysis and/or district profiling that may occur at block 406 of FIG. 4, the city guide computer 302 may analyze the times at which the restaurant transactions took place to infer what the typical business hours (by day of the week) are for restaurants in the district in question. In some embodiments, in addition to or instead of determining prevailing business hours for the district as a whole, the city guide computer 302 may infer, for a particular retail store, what its hours of operation are based on the timing of payment account transactions at the retail store in question.

In addition to or instead of restaurants, the category(ies) of merchants for which analysis is performed may include categories such as grocery stores, pharmacies, apparel stores, hotels and/or luggage stores.

The city guide computer 302 may assemble a profile for a district across a number of different categories of information, which—depending on the category of information—may or may not be determined at the granularity of the category of merchant. For example, in addition to price level and/or business hours, the categories of information in the district profile may include: an estimate of the risk of fraud; the types of currency accepted; the density of stores of a particular type; the density of ATMs; absolute numbers of stores of a given type; etc.

At 408 in FIG. 4, the city guide computer 302 may store/maintain and/or update the district profiles that were generated at 406. In addition, the stored profile data may be made available to the website hosting function of the city guide computer 302 so as to be accessible to users who access the website hosted by the city guide computer 302.

FIG. 5 is another flow chart that illustrates aspects of the present disclosure, including a portion of the operations of the city guide computer 302 (FIG. 3).

At 502, the city guide computer 302 may receive a query from a user. For example, the query may take the form of the user accessing the website hosted by the city guide computer 302. For example, the user may have interacted with an app on his/her mobile device (not shown)—such as a tablet computer or smartphone. According to one example, the user may have interacted with his/her mobile device to indicate to the app that the user is interested in information regarding the price levels of restaurants in districts that include or are near to the user's present location. The app in the user's mobile device may access the website hosted by the city guide computer 302 to obtain the information desired by the user. In doing so, the app may automatically communicate the current location of the user's mobile device.

As indicated at 504, and using the location information provided in the user's query, the city guide computer 302 may provide a location-based response to the query. That is, the response provided by the city guide computer 302 may be based on the user's current location. For example, the city guide computer 302 may look up district profiles (or the relevant portions thereof) to determine information that is responsive to the user's query. In some cases, for example, the response may take the form of data that represents a map. The data may be downloaded from the city guide computer 302 to the user's mobile device so that the map may be presented to the user as a way of providing the requested information.

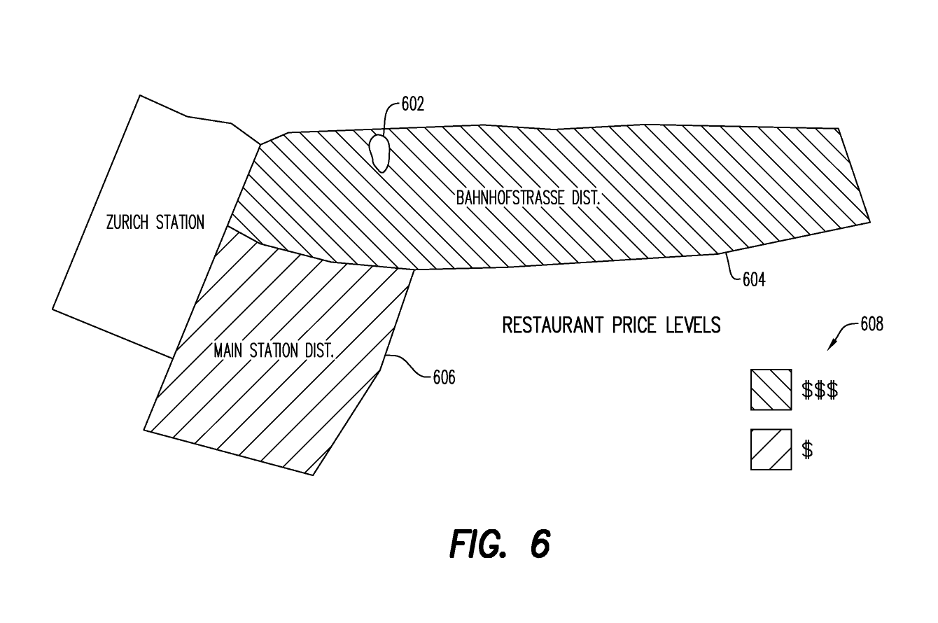

FIG. 6 is a simplified illustration of a location-based information display that may be provided on the user's mobile device in accordance with aspects of the present disclosure. That is, FIG. 6 is an example of a map that may be displayed to the user from the user's mobile device based on data representing the map that was downloaded from the city guide computer 302 as discussed in the previous paragraph.

For the purposes of the example illustrated in FIG. 6, it is assumed that the user is currently located in the Bahnhofstrasse District of Zurich, Switzerland. Marker 602 in FIG. 6 may serve to indicate to the user his/her current position relative to the area represented in the map. The heavily shaded area 604 in FIG. 6 represents the Bahnhofstrasse District. The adjoining, less heavily shaded area 606 represents the Main Station District. The different shadings of the areas 604 and 606 are meant to represent different colors or tones in which the areas are respectively presented, so as to provide a color code or “heat map” as to the restaurant price levels in the respective districts. A key presentation indicated at 608 may translate for the user the meanings of the shades or tones in terms of the price levels that they represent. In this assumed example, the key and the respective presentation of the districts indicates that the restaurant price level in the Main Station District is much less expensive than the restaurant price level in the Bahnhofstrasse District. This in turn is assumed to reflect data regarding restaurant price levels as contained in the profiles for those districts as compiled and stored in the city guide computer 302 based on payment system transaction data analyzed by the city guide computer 302.

Referring again to FIG. 5, while continuing also to refer to FIG. 6, at 506 in FIG. 5, a decision block may be provided in the process flow. At decision block 506, the city guide computer 302 may determine whether a follow-up query has been received from the user. If so, then at 508 the city guide computer 302 may provide the user with an opportunity to “drill down” for additional information and/or to navigate to location-based information available in the district profiles maintained in the city guide computer 302 and/or to search for information stored in the city guide computer 302. To provide one example of such a follow-up query, suppose the user touches/clicks-on the area 606 shown in FIG. 6. A menu (not shown) may then pop up to allow the user to request locations of restaurants in the Main Station District in Zurich. The user's request of this kind may constitute the follow-up query referred to above in connection with the discussion of decision block 506. The city guide computer 302 may respond to the follow-up query, in this instance, by retrieving—from the profile for the Main Station District—the names and locations of restaurants in that district that are currently open for business, according to the hours of operation that had been previously been inferred for those restaurants—and stored—by the city guide computer 302. The city guide computer 302 may then download to the user's mobile device an updated map display (not shown) pinpointing the locations and indicating the names of the currently open restaurants in the Main Station District. In an example of a further follow-up query that may take place, the user may touch the displayed name (not shown) of a restaurant to request from the city guide computer 302 information such as the type of cuisine served at the restaurant in question. The user may then select a map/directions function so that his/her mobile device displays a walking route to a particular restaurant that the user has decided to select for dinner.

According to some embodiments, there are many possible variations or alternatives to the example query(ies) and response(s) described above within the scope of the teachings of this disclosure. For example, the user may have inquired about a category of merchant other than restaurants. As another example, the user's query may have related to types of currency accepted by merchants in a certain category rather than relating to prevailing price levels in nearby districts for a category of merchant. In another example query, the user may ask that the city guide computer 302 provide location information for currently open nearby stores in a particular merchant category. As another possible query, the user may have asked the city guide computer 302 for an indication of prevailing hours of operation of a certain category of merchant in the district where the user is currently located and/or in adjoining districts. As still another possible query, the user may request the locations of nearby ATMs. In all of these cases, the city guide computer 302 may respond to the queries based on one or more district profiles stored in the city guide computer 302 and derived at least in part from analysis of payment system transaction data. In a case where the user's query relates to a type of merchant, the city guide computer 302 may determine which merchant that is currently open (based on hours of operation inferred from analysis of transaction data) is closest to the user's current location, and may download the merchant's name and location to the user's mobile device.

In embodiments in accordance with teachings of this disclosure, valuable information for travelers may be generated and compiled based on analysis of payment system transaction data. In some embodiments, the resulting information may be stored in the form of district profiles that correspond to districts in many cities around the world. The district profile information may be used to respond to queries from users received via a website hosted by a server computer. The responses to the queries may particularly be useful in suggesting the desirability of one or more districts in satisfying the user's current needs as reflected in the user's query.

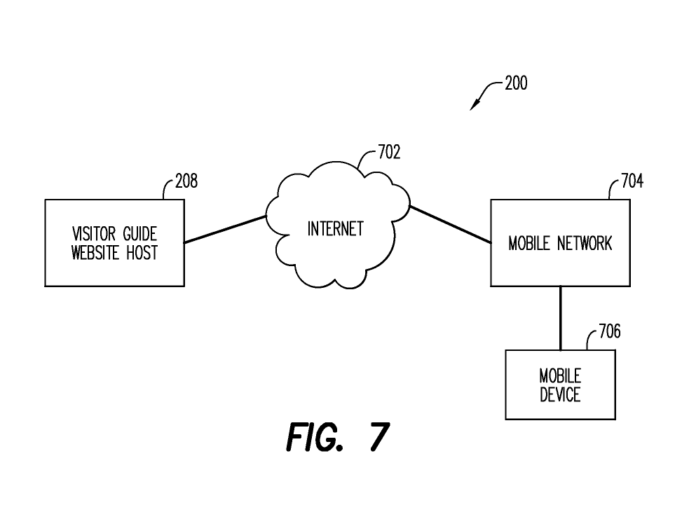

FIG. 7 is a block diagram that shows other aspects of the system 200 that is also illustrated in FIG. 2. FIG. 7 shows the same visitor guide website host computer 208 as is also represented in FIG. 2. In FIG. 7, the visitor guide website host computer 208 is shown connected for data communication via the intern& 702 and a mobile communication network 704 with a user's mobile device 706. The mobile device 706 may function to present to the user (not shown) a map/display like that illustrated (as an example) in FIG. 6. The mobile device 706 may, for example, be a smartphone or a tablet computer.

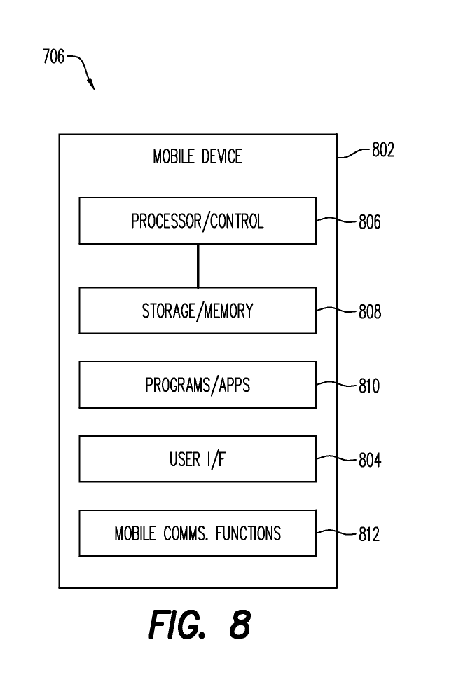

FIG. 8 is a block diagram of an example embodiment of the mobile device 706 shown in FIG. 7.

The mobile device 706 may include a housing 802. In many embodiments, the front of the housing is predominantly constituted by a touchscreen (not separately shown), which is a key element of the user interface 804 of the mobile device 706.

The mobile device 706 further includes a conventional mobile processor/control circuit 806, which is contained within the housing 802. Also included in the mobile device 706 is a storage/memory device or devices (reference numeral 808). The storage/memory devices 808 are in communication with the processor/control circuit 806 and may contain program instructions to control the processor/control circuit to manage and perform various functions of the mobile device 706. As is well-known, such functions may include operation as a mobile voice communication device via interaction with a mobile communication network (FIG. 7, item 704). Further conventional functions include operation as a mobile data communication device, and also as what is in effect a pocket-sized personal computer, via programming with a number of application programs, or “apps”. (The apps are represented at block 810 in FIG. 8, and may in practice be stored in block 808, to program the processor/control circuit 806 in myriad ways.) The above-referenced mobile communications functions are represented by block 812, and in addition to programmed control functions, the mobile communications functions also rely on hardware features (not separately shown) such as an antenna, a transceiver circuit, a microphone, a loudspeaker, etc.

In some embodiments, the mobile device 706 may have been programmed with a suitable app (not separately represented) to facilitate interactions between the mobile device 706 and the visitor guide website host computer 208 (FIG. 7).

From the foregoing discussion, it will be appreciated that the blocks depicted in FIG. 8 as components of the mobile device 706 may in effect overlap with each other, and/or there may be functional connections among the blocks which are not explicitly shown in the drawing.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles payment card transactions. The term “payment card” includes a credit card, debit card, prepaid card, or other type of payment instrument, whether an actual physical card, electronic, or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving transaction data from a payment network, the transaction data representing payment account transactions;
associating a subset of the transaction data with a district in an urban area;
generating a summary characteristic of the district on the basis of the associated subset of transaction data;
representing the district on a map by a color or shade, said color or shade determined at least in part by said generated summary characteristic;
receiving location information indicative of a user's current location from a user's mobile device; and
transmitting the map to the user's mobile device for presentation to the user, the map configured based at least in part on the user's current location.

2. The method of claim 1, wherein the summary characteristic is a price level in at least one category of merchant.

3. The method of claim 2, wherein the at least one category of merchant includes at least one of restaurants, grocery stores, pharmacies, apparel stores, hotels and luggage stores.

4. The method of claim 1, wherein the summary characteristic is prevailing business hours.

5. The method of claim 1, wherein said assigning is based on locations of merchants represented in the subset of transaction data.

6. The method of claim 1, further comprising:
characterizing the district as to at least one of (a) estimated risk of fraud; (b) types of currency accepted; (c) density of stores of a particular type; (d) density of ATMs (automatic teller machines); and absolute number of stores of a particular type.

7. The method of claim 1, further comprising:
receiving, from the user's mobile device, an indication of a type of information that the user desires to obtain concerning the district.

8. An apparatus comprising:
a processor; and
a memory in communication with the processor and storing program instructions, the processor operative with the program instructions to perform functions as follows:
receiving transaction data from a payment network, the transaction data representing payment account transactions;
associating a subset of the transaction data with a district in an urban area;
generating a summary characteristic of the district on the basis of the associated subset of transaction data;
representing the district on a map by a color or shade, said color or shade determined at least in part by said generated summary characteristic;
receiving location information indicative of a user's current location from a user's mobile device; and
transmitting the map to the user's mobile device for presentation to the user, the map configured based at least in part on the user's current location.

9. The apparatus of claim 8, wherein the summary characteristic is a price level in at least one category of merchant.

10. The apparatus of claim 9, wherein the at least one category of merchant includes at least one of restaurants, grocery stores, pharmacies, apparel stores, hotels and luggage stores.

11. The apparatus of claim 8, wherein the summary characteristic is prevailing business hours.

12. The apparatus of claim 8, wherein said assigning is based on locations of merchants represented in the subset of transaction data.

13. The apparatus of claim 8, wherein the processor is further operative with the program instructions to
characterize the district as to at least one of (a) estimated risk of fraud; (b) types of currency accepted; (c) density of stores of a particular type; (d) density of ATMs (automatic teller machines); and absolute number of stores of a particular type.

14. A method comprising:
receiving transaction data from a payment network, the transaction data representing payment account transactions;
analyzing said transaction data to assemble a data profile for a district in an urban area, said data profile indicating, for said district: (a) a price level for at least one category of merchant; (b) hours of operation for said at least one category of merchant; (c) an estimate of fraud risk for said at least one category of merchant; (d) types of currency accepted by said at least one category of merchant; (e) density of stores for said at least one category of merchant; and (f) density of ATMs; said data profile including district profile data;
receiving a location-based inquiry from a mobile device; and
transmitting at least some of the district profile data to the mobile device in response to the received location-based inquiry.

15. The method of claim 14, wherein said at least one category of merchant includes restaurants.

16. The method of claim 14, wherein said at least one category of merchant includes pharmacies.

17. The method of claim 14, wherein said at least one category of merchant includes apparel stores.

18. The method of claim 14, wherein said at least one category of merchant includes luggage stores.

19. The method of claim 14, wherein said at least one category of merchant includes grocery stores.

20. The method of claim 14, wherein said analyzing includes:
assigning a subset of said transaction data to said district based on respective locations of merchants represented in said subset of transaction data.
